(19) United States
(12) Patent Application Publication
(10) Pub. No.: US 2006/0052892 A1
(43) Pub. Date: Mar. 9, 2006

(54) Product design method, product design apparatus, product design system, and product design program

(76) Inventors: Hideyuki Matsushima, Taipei City (TW); Makoto Takayama, Macon, GA (US); Nobuhiro Ichikawa, Namerikawa-shi (JP); Nobuyuki Miyazaki, Kurobe-shi (JP)

Correspondence Address: Michael S. Leonard;Everest Intellectual Property Law Group, P.O. Box 708, Northbrook, IL, 60065, US

(21) Appl. No.: 11/188,684

(22) Filed: Jul. 25, 2005

(30) Foreign Application Priority Data
Sep. 3, 2004 (JP) 2004-257493

(51) Int. Cl. G06F 19/00

(52) U.S. Cl. 700/98; 700/97

(57) ABSTRACT

A product design apparatus (2) includes: a storage unit (20) for storing 3D CAD-based model data (21) of a plurality of products different from one another in terms of design and 2D product projection data (22) corresponding to the 3D CAD-based model data; a list display section (27) for displaying a list of the product projection data (22) on a screen; a 3D modeling program (25) for displaying the 3D CAD-based model data corresponding to the specified product projection data on the screen and for performing a shape modification through an operator's operation; and the storage unit (20) for storing designed data (24). Since a design can be performed based on the data that has been selected from the displayed data list, a product close to the customer's image can be designed in a short time, thereby shortening the time for determination of the design.

### BACKGROUND OF THE INVENTION

1. Field of the Invention

The present invention relates to a product design method, a product design apparatus, a product design system, and a product design program and, more particularly, to a design of various products that is determined by a meeting with an apparel manufacturer as a sales destination, the various products including, for example, a slide fastener, button, a coupling tool such as buckle, and a locking tool such as a cord stopper that are used for apparel products or the like.

2. Description of Related Art

Fashion-related articles such as garments, bags, and shoes are designed, manufactured (including the case of outsourcing), and sold by a manufacturer that deals with those articles.

A slide fastener, button, coupling tool (buckle, karabiner, adjuster, etc.), and locking tool (cord stopper, cord end, etc.) are often used in the above articles. These products such as a fastener are not manufactured by the apparel manufacturer but by a parts manufacturer, in general.

The parts manufacturer manufactures products such as a slide fastener used in such fashion-related articles based on design information that sales representative of the parts manufacturer have obtained from manufactures of garments, bags, or shoes according to the procedure including: sample preproduction, sample presentation, design modification, second sample reproduction, second sample presentation, and approval (refer to Japanese Patent Laid-Open Publication No. 2002-207507, Paragraph Nos. 0002 to 0006).

However, in many cases, a negotiation between the fashion-related manufacturers of garments, bags, or shoes and parts manufacturer is made through sales representative, FAX, or E-mail, taking a considerable amount of time to determine the design of a final product.

Further, an instruction from the manufacturers of garments, bags, or shoes is made through a design drawing or the like created by a designer. Therefore, the designer of the manufacturers of garments, bags, or shoes and a designer on the parts manufacturer side who reflects the design from the fashion-related manufacturer to actual design data cannot communicate with each other directly in some cases, which makes it difficult for the designer on the parts manufacturer side to design a preproduction sample which meets the image of the designer. As a result, additional preproduction work may be required and the product shipment may fail to meet the date specified by the manufacturers of garments, bags, or shoes.

### SUMMARY OF THE INVENTION

An object of the present invention is to provide a product design method, a product design apparatus, a product design system, and a product design program capable of significantly reducing the required time to determine a product design and, more preferably, capable of reducing the time required for die machining, and capable of manufacturing parts at the most suitable location.

According to a first aspect of the present invention, there is provided a product design method for designing a product using a computer, including: a data preparation process in which 3D CAD-based model data serving as basic shapes of a plurality of products different from one another in terms of design and 2D product projection data corresponding to the 3D CAD-based model data are prepared; a list display process in which a list of the plurality of product projection data is displayed on a screen of the computer; a detailed design process in which the 3D CAD-based model data corresponding to the product projection data selected from the displayed product projection data list is displayed on the screen and the shape modification of the 3D CAD-based model data is performed through an operator's operation.

In the present invention, since the list of the plurality of product projection data can be displayed, the design closest to the customer's image can be selected during a designing meeting with the customer designer. The 3D CAD-based model data corresponding to the selected projection data is then called up and the shape of the model data is modified to complete the design of a product meeting the customer's image. Since a product can be designed based on the data closer to the customer's desired image, it is possible to complete a detailed design work in a shorter time as compared to the case where the 3D CAD-based model data has not been prepared. Further, in selecting the 3D CAD-based model data, a list of the projection data corresponding to the 3D model is displayed, so that the customer can easily select the data close to his or her image from the plurality of model data. Thus, also in this regard, it is possible to complete the design work in a short period of time.

As a result, it is possible to significantly shorten the time required for the determination (approval) of the product design, as compared to a conventional product designing procedure.

It is preferable that the 3D CAD-based model data is parametric data having parameters for the shape modification, and the operator changes the parameters to modify the shape of the 3D CAD-based model data.

In the parametric 3D CAD-based model, since the shape modification can be performed by changing the parameters, the operation is easier than in the case where other 3D CAD-based model is employed, which enables even the sales representative to treat. Therefore, the sales representative can directly have a meeting with the customer at the customer's company or the like while using a computer that can execute the product design method of the present invention. By having a meeting directly with the customer, it is possible to further shorten the time required for the determination (approval) of the design.

It is preferable that the product design method according to the present invention includes an estimation creation process in which estimation of the price of a product is created based on the 3D CAD-based model data whose shape has been modified in the detailed design process.

In the present invention, the price of the product can be estimated based on the designed model data, so that the estimated price can be presented to the customer at the meeting time. Thus, it is possible to gain approval for the design at the meeting time, thereby reducing the time until the contract is concluded.

It is preferable that the product design method according to the present invention includes a manufacturing condition input process in which manufacturing condition data including at least a product material and manufacturing method is input, and in the estimation creation process, estimation of the price of the product be created based on the 3D CAD-based model data and the manufacturing condition data.

When the manufacturing condition data including the product material and the manufacturing method is input in the estimation creation, more reliable estimation can be created, enabling even an inexperienced sales representative to quickly create the estimation. Thus, also in this regard, it is possible to shorten the time required for gaining the customer's approval.

It is preferable that the product design method according to the present invention includes a 2D design drawing creation process in which a 2D design drawing is created based on the 3D CAD-based model data whose shape has been modified in the detailed design process.

The created 2D design drawing serves as a reference for manufacturing/processing the actual product, enhancing efficiency of the manufacturing/processing work.

It is preferable that the product is a slide fastener, slide fastener part, button, coupling tool, or locking tool.

The product design method according to the present invention can be used for the design of various products. In particular, the product design method is suitable for the design of various parts used for fashion-related articles having a great deal of design variation. When the present invention is used for the design of a slide fastener, a slide fastener parts (puller, slider), a button, a coupling tool (buckle, karabiner, adjuster, etc.), and a locking tool (cord stopper, cord end, etc.), a product design process can be effectively performed to shorten the time required for the design determination.

It is preferable that the product design method according to the present invention includes a browse data creation process in which browse data is created based on the designed 3D CAD-based model data and a browse data display process in which the browse data is displayed when an instruction to display the crated browse data is issued.

The browse data is view data by which a user can check the 3D shape of the product. The shape of the browse data cannot be modified but the data amount thereof is smaller than the 3D CAD-based model data, enabling the user to easily browse the browse data through an electrical communication line such as the Internet. It is preferable that the browse data can be displayed on an Internet browser.

The browse data creation process and browse data display process allow the design data that has been created on other computers to be easily checked by the browse data. Therefore, operators in the manufacturing plant or other sales representatives can check the product design and utilize it as a reference at the time of manufacturing the product or at the time of sales.

It is preferable that the product design method according to the present invention includes a process data creation process in which product process data is created based on the designed 3D CAD-based model data and a process data transfer process in which the created product process data is transferred to a manufacturing plant.

The product process data is the data required for the processing work, such as various dimensions, materials or the like of the designed product. The process data may be of a type that can be directly input to molding or processing machines, or of a type that allows an operator of the molding or processing machines to refer to at the time of operating the machines.

The process data creation/transfer processes allow the processing/manufacturing of the product to be easily performed based on the design data. In particular, it is possible to create a product sample in a short time based on the designed data. Therefore, the time required for the customer to check the sample and approve the design can also be shortened.

It is preferable that the product design method according to the present invention includes a product sample creation process in which a rapid prototyping technology is used to create a product sample based on the designed 3D CAD-based model data.

Examples of the rapid prototyping technology (RP) that can be used here include known rapid prototyping technology such as an optical modeling method, powder sintering method, ink-jet method, sheet laminating method, extrusion method, and other modeling methods. When the above rapid prototyping technology is used to create a product sample, it is possible to obtain the 3D model of the designed product in a very short time. Thus, the customer can visually check the product sample to approve, which makes it easy to grasp the actual product image while shortening the time until the customer approves the design.

The product sample creation process may be performed in the plant that actually manufactures the product, the business site, or at the meeting site with the customer. In particular, when a 3D printer (3D modeling apparatus) utilizing the ink-jet method or the like is used to create the product sample, it is possible to carry the 3D printer to the customer's company and create the product sample there as well as to install the 3D printer at the business site, since the size reduction of the 3D printer has been achieved comparatively.

When the product sample is created at the site near the customer's location, such as business site or customer's company, it is possible to shorten the time for presenting the product sample to the customer and thereby to further shorten the time for the customer's design approval.

In the case where the 3D printer or the like is installed in the plant or at the business site and the sales representative has a design meeting with the customer at the customer's company, a sample may be output using the 3D printer or the like after returning to the plant or business site after the meeting. When the 3D printer is connected to the computer that the sales representative uses in the meeting at the customer's company through a communication line such as the Internet, the data can be transmitted to the 3D printer and output during the meeting. By transmitting the data from the customer's company to output the sample, the time required to create the sample can be shortened.

In the product sample creation process using the rapid prototyping technology, a sample having the same shape as the designed product is created using a different material (photopolymerizable resin, etc.) from that of the actual product, in general. On the other hand, in the case of the powder sintering method, ceramics or metallic powder can be used, so that a sample made of the same material as the actual product can also be created. When the sample made of the same material as the actual product can be obtained as described above, the customer can grasp the texture of the actual product, resulting in further reducing the time for the customer's design approval.

It is preferable that the product design method according to the present invention includes a metal mold creation process in which the rapid prototyping technology is used to create the metal mold of the product based on the designed 3D CAD-based model data and a trial product manufacturing process in which the metal mold that has been created in the metal mold creation process is used to create the product sample.

The rapid prototyping technology (RP) may be a technology that can create the metal mold using a metallic material like the abovementioned powder sintering method. When the rapid prototyping technology is used to create the metal mold and the created metal mold is used to manufacture the product sample, the 3D modeling product corresponding to the designed product can be created in a very short time. Therefore, the customer can approve the design by visually confirming the product sample. Further, it is possible for the customer to easily grasp the actual product image and thereby to shorten the time until the design approval is obtained.

Although the metal mold creation process and trial product manufacturing process are usually performed in the plant that actually manufactures the product, the above processes may be performed in the business site or at the meeting site with the customer. In particular, in the case of manufacturing the slide fastener or button, since the size is very small, a small-sized injection molding machine can be used. Thus, when a machine for creating the metal mold using the powder sintering method and another machine such as the injection molding machine for manufacturing the product using the metal mold are installed on a truck or a trailer and conveyed to the business site or customer's company, the metal mold and product sample can be created at the location near the customer's location, such as the business site or customer's company. As a result, it is possible to shorten the time for presenting the product sample to the customer and thereby to further shorten the time for obtaining the customer's design approval.

Further, when the metal mold is created for manufacturing the product sample, the possible problem in the actual manufacturing process can be verified, and thereby design errors such as designing an unmanufacturable product can be checked in advance and prevented.

According to a second aspect of the present invention, there is provided a product design apparatus which uses a computer to design a product, including: a base data storage unit which stores 3D CAD-based model data of a plurality of products different from one another in terms of design and 2D product projection data corresponding to the 3D CAD-based model data; a list display section which displays a list of the plurality of product projection data on a screen of the computer; a detailed design unit which displays the 3D CAD-based model data corresponding to the product projection data selected from the displayed list of product projection data and performs the shape modification of the 3D CAD-based model data through an operator's operation; and a design data storage unit which stores the 3D CAD-based model data that has been designed by the detailed design unit.

Also in the present invention, since the list of the plurality of product projection data can be displayed, the design closest to the customer's image can be selected during a designing meeting with the customer designer. The 3D CAD-based model data corresponding to the selected projection data is then called up and the shape of the model data is modified to complete the design of a product in the customer's image. Since a product can be designed based on the data closer to the customer's desired image, it is possible to complete a detailed design work in a shorter time than in the case where the 3D CAD-based model data has not been prepared. Further, in selecting the 3D CAD-based model data, since the list of the projection data corresponding to the 3D model is displayed, the customer can easily select the data close to his or her image from the plurality of model data. Thus, also in this regard, it is possible to complete the design work in a short period of time.

As a result, the time required for the determination (approval) of the product design can be significantly shortened, as compared to the conventional product designing procedure.

In the product design apparatus of the present invention, it is preferable that the 3D CAD-based model data is parametric data having parameters for the shape modification, and that the detailed design unit changes the parameters to modify the shape of the 3D CAD-based model data.

Further, it is preferable that the product design apparatus according to the present invention includes an estimation creation unit which creates estimation of the price of the product based on the 3D CAD-based model data whose shape has been modified by the detailed design unit.

In this case, it is preferable that the estimation creation unit includes a manufacturing condition input section for inputting manufacturing condition data including at least a product material and manufacturing method and creates estimation of the price of the product based on the 3D CAD-based model data and the manufacturing condition data.

It is preferable that the detailed design unit includes a 2D design drawing creation section for creating a 2D design drawing based on the 3D CAD-based model data.

Further, it is preferable that the product is a slide fastener, a slide fastener part, a button, a coupling tool, or a locking tool.

With the above arrangements of the present invention, the same advantages as those of the counterparts of the aforementioned invention can be obtained.

According to a third aspect of the present invention, there is provided a product design system including: the aforementioned product design apparatus of the present invention; a database server connected to the product design apparatus through an electrical communication line and storing 3D CAD-based model data that has been designed by the product design apparatus; a browse data server connected to the database server through an electrical communication line and including a browse data creation unit which creates browse data based on the 3D CAD-based model data stored in the database server and a data storage unit which stores the browse data; and a data browsing apparatus connected to the browse data server through an electrical communication line and including a browse data display unit which displays the browse data stored in the browse data server.

According to the present invention described above, the 3D CAD-based model data that have been designed on the product design apparatuses are stored in the database server, so that the 3D CAD-based model data can be selected from the 3D CAD-based model data including those that have been previously designed when the next product is designed. Therefore, a product design work can be performed in a shorter time.

Further, since the system includes the browse data server and data browsing apparatus, the 3D shape of the designed product can be checked even on the computer that is not provided with the system capable of modifying the shape of the 3D CAD-based model data, which fabricates manufacturing of the product close to the customer's image, especially in manufacturing products.

Further, it is preferable that the product design system according to the present invention includes a process data creation/transfer server connected to the database server through an electrical communication line and including a process data creation unit which creates product process data based on the 3D CAD-based model data stored in the database server and a process data transfer unit which transfers the product process data to a manufacturing plant.

With the process data creation/transfer server, the processing and manufacturing of the product can be performed based on the design data by transferring the process data to the manufacturing plant that actually manufactures the product. Therefore, a product sample can be created in a short time based on the design data, thereby reducing the time required for obtaining customer's approval.

It is preferable that the product design system according to the present invention includes a 3D modeling apparatus using a rapid prototyping technology to create a product sample based on the 3D CAD-based model data that has been designed by the product design apparatus.

With the 3D modeling apparatus, it is possible to create the product sample by using the rapid prototyping technology. Therefore, as in the case of the product design method, a 3D modeling product corresponding to the designed product can be created in a very short time. Thus, the customer can approve the design by visually checking the product sample, so that the actual product image can be easily grasped which shortens the time until the customer approves the design.

It is preferable that the product design system according to the present invention includes a metal mold creation apparatus which uses the rapid prototyping technology to create the metal mold of a product based on the 3D CAD-based model data designed by the product design apparatus and a trial product manufacturing apparatus which uses the metal mold created by the metal mold creation apparatus to manufacture a trial product.

With the metal mold creation apparatus and trial product manufacturing apparatus, a product sample can be manufactured using the metal mold that has been created using the rapid prototyping technology, so that the 3D modeling product corresponding to the designed product can be created in a very short time, as in the case of the product design method. Therefore, the customer can approve the design by visually checking the product sample, so that the customer can easily grasp the actual product image, which shortens the time until the design approval is obtained. Further, when the metal mold is created for manufacturing the product sample, the possible problem in the actual manufacturing process can be verified, thereby preventing design errors such as designing an unmanufacturable product can be checked in advance and prevented.

It is preferable that a product design program according to the present invention allows a computer to execute the aforementioned product design method of the present invention.

With the above invention, the same advantages as those of the product design method can be obtained.

Further, the program can be installed and incorporated in the computer through a recording medium such as a CD-ROM or a communication line such as the Internet. Therefore, the customers and designers can design various products by installing the program in their own computers.

### BRIEF DESCRIPTION OF THE DRAWINGS

FIG. 1 is a block diagram showing a puller design production management system according to a first embodiment of the present invention;

FIG. 2 is a view showing the arrangements of a design-puller designing apparatus, a database server, and a database management apparatus according to the embodiment;

FIG. 3 is a view showing the arrangements of a browse data server, a process data creation/transfer server, and a data browsing apparatus according to the embodiment;

FIG. 4 is a flowchart showing a puller design procedure in the design-puller designing apparatus according to the embodiment;

FIG. 5 is a view showing a manufacturing condition input window according to the embodiment;

FIG. 6 is a view showing a list display window according to the embodiment;

FIG. 7 is a view showing a design editing window according to the embodiment;

FIG. 8 is a view showing a 2D design drawing according to the embodiment;

FIG. 9 is a view showing a confirmation window according to the embodiment;

FIG. 10 is a flowchart showing a data management and product manufacturing procedure according to the embodiment; and

FIG. 11 is a flowchart showing a puller design procedure according to a second embodiment of the present invention.

### DETAILED DESCRIPTION OF PREFERRED EMBODIMENTS

A designing system of a puller of a slide fastener according to a first embodiment of the present invention will be described below with the accompanying drawings.

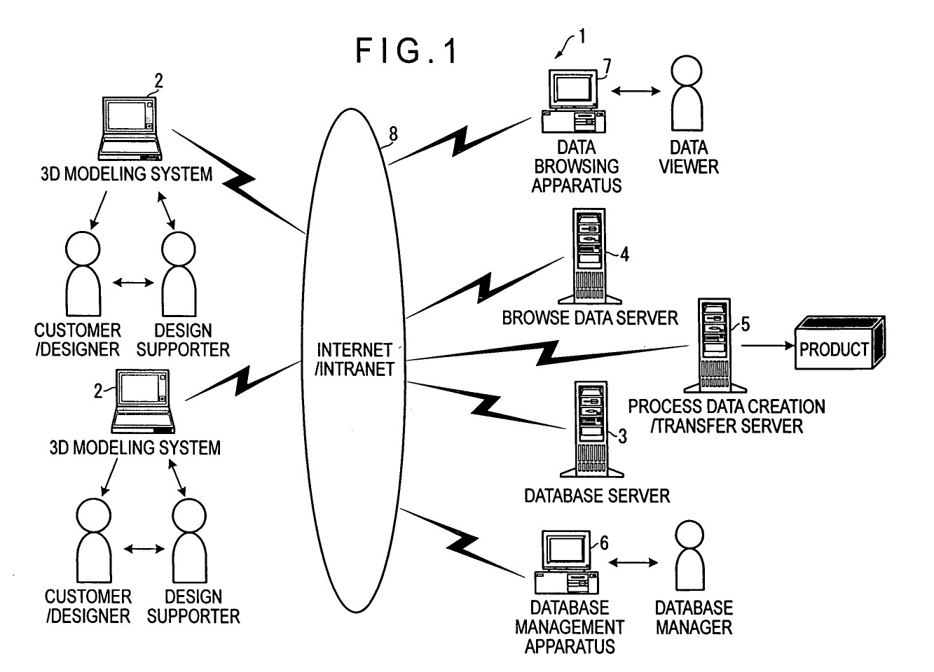

FIG. 1 shows a puller design production management system 1 of a slide fastener including a design-puller designing apparatus (3D modeling system) 2 of the slide fastener according to the first embodiment. In other words, the puller design production management system 1 constitutes the product design system of the present invention, and the design-puller designing apparatus 2 constitutes the product design apparatus of the present invention.

The puller design production management system 1 includes the design-puller designing apparatus 2, a database server 3, a browse data server 4, a process data creation/transfer server 5, a database management apparatus 6, and a data browsing apparatus 7.

The design-puller designing apparatus 2, servers 3 to 5, database management apparatus 6, and data browsing apparatus 7 are constituted by computers which are connected to each other through an electrical communication line 8 such as the Internet or Intranet in a communicable manner.

Each of the above computers is a commonly used computer including a display unit (display section) such as a CRT and a liquid crystal display, an input unit (input section) such as a keyboard, numerical key and mouse, a processing unit (processing section, controller) such as a CPU, a storage (storage unit) such as a hard disk or memory. Each of the computers also includes communication devices, such as a modem, a terminal adapter and a router, for connecting to the electrical communication line 8.

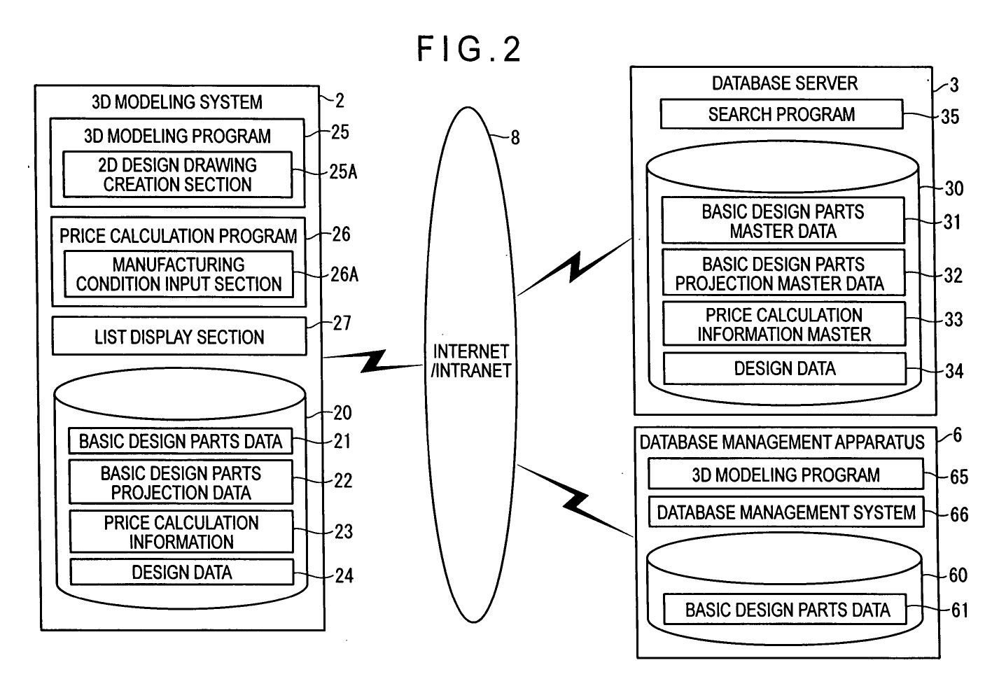

The database server 3 is generally installed in a manufacturer that manufactures the slide fastener puller, and the storage 30 of the database server 3 stores, as shown in FIG. 2, basic design parts master data 31, basic design parts projection master data 32, price calculation information master 33, and design data 34. The data base server 3 also incorporates a search program 35 for searching the above data that have been stored in the storage 30.

The basic design parts master data 31 serves as master data for designing various types of pullers and includes various pullers different in shape and design registered as the master data. The basic design parts master data 31 is constituted by data (3D CAD-based model data) whose shape can be modified in the design-puller designing apparatus 2 employing a 3D modeling system. In the case where the 3D modeling system of the design-puller designing apparatus 2 is, for example, a parametric 3D CAD system, the data constituting the basic design parts master data 31 is 3D CAD-based model data whose shape can be modified parametrically.

The basic design projection master data 32 is 2D image data (product projection data) obtained by projecting the data of the basic design parts master data 31. The data amount of the 3D CAD-based model data is so large that it takes long time to display a list of a great number of master data. Therefore, a list of the registered basic design parts master data 31 is not displayed but a list of the corresponding basic design parts projection master data 32 is displayed. This reduces the data amount at the time of displaying a list of the registered puller designs and thereby the design list can quickly be displayed.

The price calculation information master 33 stores information required to calculate a retail price of the designed puller. For example, basic information required for price calculation, such as material cost (per unit weight) for each material of the puller, processing cost such as surface finishing or manufacturing process, exchange rate, and sales administrative expense, is stored in the price calculation information master 33.

In the design data 34, the design data (3D CAD-based model data) designed in the design-puller designing apparatus 2 is accumulated and stored.

The search program 35 searches design data according to search condition that has been input through the design-puller designing apparatus 2, database management apparatus 6, data browsing apparatus 7 and the like and outputs the search result. For example, customer name, puller size, creation date, code assigned to the respective design data and the like can appropriately be set as search condition.

The database management apparatus 6 includes a storage 60 which stores basic design parts data 61 which is 3D CAD-based model data, a 3D modeling program (3D CAD) 65, and a database management system 66.

The 3D modeling program 65 is a detailed design unit for creating new basic design parts data based on the basic design parts data 61 and is generally constituted by a program installed in a computer. In other words, the basic design parts data 61 stores standard design data of the puller. A database manager or the like can use the 3D modeling program 65 to design the puller data as a new basic design parts data 61 based on the design data.

The database management system 66 is a system that manages the database server 3, which is constituted by a program installed in a computer. In the database management system 66, the basic design parts data 61 that has been newly designed in the 3D modeling program 65 can be registered in the basic design parts master data 31 of the database server 3, creation of the basic design parts projection master data 32 corresponding to the basic design parts master data 31 can be registered, and the information of the price calculation information master 33 can be input or changed.

The design-puller designing apparatus 2 as the product design apparatus of the present invention includes a storage 20 storing basic design parts data 21, basic design parts projection data 22, price calculation information 23, and design data 24.

The basic design parts data 21 and basic design parts projection data 22 are the data respectively copied from the basic design parts master data 31 and basic design parts projection master data 32 and stored in the storage 20. All the data in the basic design parts master data 31 and basic design parts projection master data 32 may be stored in the storage 20, or only a part of the data may be stored in accordance with necessity.

The design data 24 is 3D CAD model data designed using the design-puller designing apparatus 2.

In other words, the storage 20 constitutes: a base data storage unit that stores basic design parts data 21 which is the 3D CAD-based model data and basic design parts projection data 22 as the product projection data; and a design data storage unit that stores the design data 24 which is the designed 3D CAD model data.

The design-puller designing apparatus 2 further includes a 3D modeling program (3D CAD) 25 serving as a detailed design unit that creates and modifies the design data 24 which is 3D CAD data, a price calculation program 26 serving as an estimation creation unit that calculates a price based on the price calculation information 23 and creates an estimation, and a list display section 27 that displays a list of the basic design parts projection data 22 on a display window.

The 3D modeling program 25 includes a 2D design drawing creation section 25A which creates 2D design drawing data based on the design data 24.

The price calculation program 26 includes a manufacturing condition input section 26A for inputting a product material, manufacturing method, and the like.

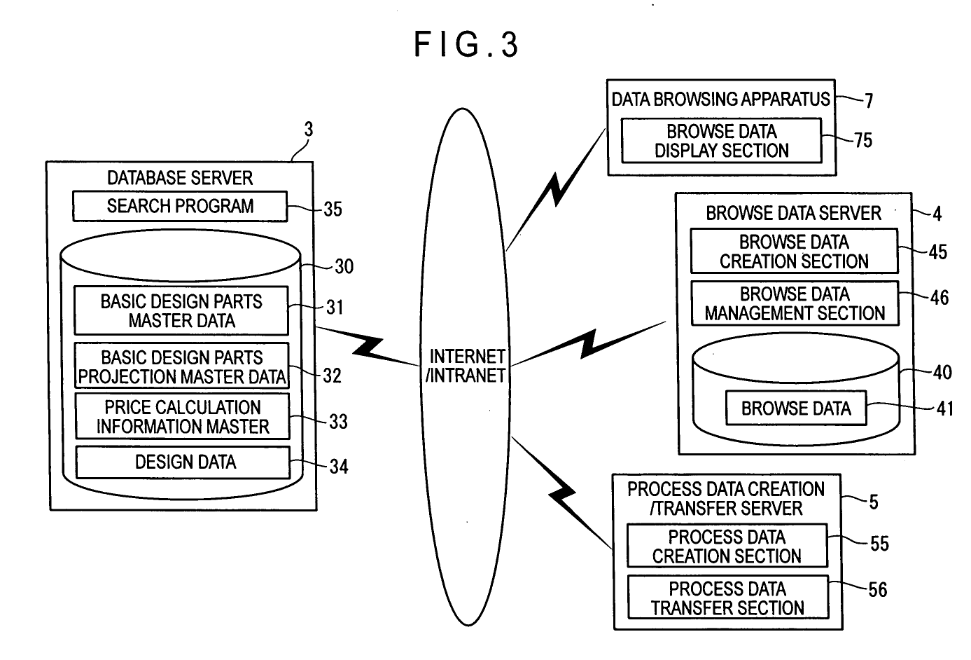

The browse data server 4 includes, as shown in FIG. 3, a storage 40 serving as a data storage unit for storing browse data 41, a browse data creation section 45 serving as a browse data creation unit, and a browse data management section 46.

The browse data creation section 45 is constituted by a program and the like that creates the browse data 41 corresponding to respective design data 34 based on the design data 34 accumulated in the database server 3.

The browse data 41 is 3D view data (plan representation data) through which the 3D shape of the designed puller can be checked. The browse data 41 is used exclusively for browsing and cannot be modified. The data amount of the browse data can be reduced, so that the browse data can be displayed by a browser through a communication network such as the Internet.

The browse data 41 created in the browse data creation section 45 is stored in the storage 40.

The browse data management section 46 is a program or the like for executing a data management process for allowing the browse data 41 to be released or for allowing the browse data 41 to be viewed by users.

The data browsing apparatus 7 includes a browse data display section 75 serving as a browse data display unit. The browse data display section 75 is a program or the like for accessing the browse data management section 46 of the browse data server 4 to display the browse data 41. For example, when the browse data management section 46 functions as a web server, the browse data display section 75 can be constituted by a browser or the like that can access the browse data management section 46.

In the above arrangement, since the data browsing apparatus 7 is only required to have a browser incorporated therein, the data browsing apparatus 7 can be constituted by devices such as a PDA or mobile phone having a browser function, in addition to a desktop or laptop computer (personal computer).

The process data creation/transfer server 5 includes a process data creation section 55 serving as a process data creation unit and a process data transfer section 56 serving as a process data transfer unit.

The process data creation section 55 is constituted by a program or the like that creates a process data for processing and manufacturing the designed product (puller) based on the design data 34 of the database server 3.

The process data transfer section 56 is constituted by a program or the like that transfers the process data created in the process data creation section 55 to a processing plant.

The process data is the data required for the processing work, such as various dimensions of the designed product (puller) and a material code. The process data may be of a type that can be directly input to molding machines or processing machines, or of a type that an operator of the molding or processing machines refers to at the time of operating the machines.

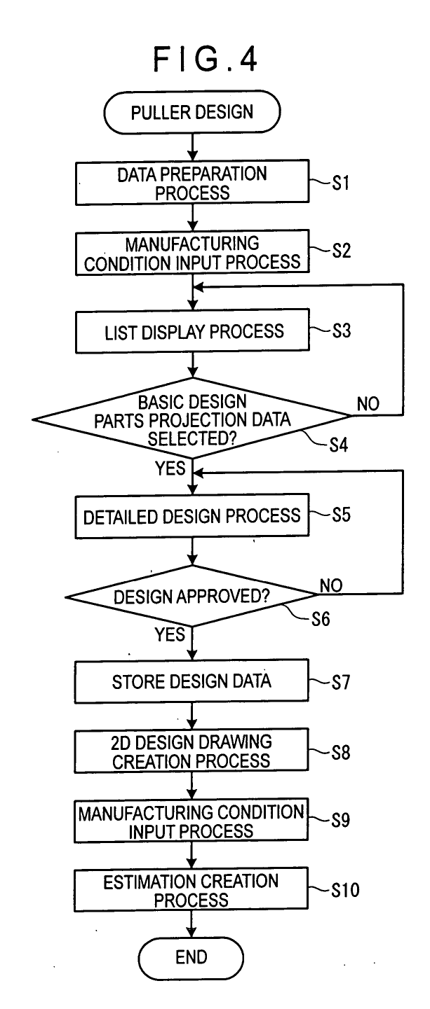

Next, a method of designing the puller according to the present embodiment performed using the design-puller designing apparatus 2 will be described with reference to the flowchart of FIG. 4.

A manufacturer's design supporter (sales representative and/or designer, etc.) carries out a data preparation process to copy (download) the basic design parts data 21, basic design parts projection data 22, price calculation information 23, and design data 24 from the database server 3 to the design-puller designing apparatus 2 being a laptop computer for storing the above data in the storage 20 (step 1, hereinafter, “step” is abbreviated as “S”).

In the data preparation process, the design supporter previously inputs various information as needed. For example, a fastened which is a product to be presented to a customer includes a slider having a puller and a body and a chain having an element and a tape, so that information the slider, chain, and the like in addition to the information of the puller is required for cost calculation. Therefore, the design supporter previously inputs various information required to calculate the cost of the slider, such as a chain code indicating the type of a chain, a size code indicating the size of a fastener, information of a slider, information of materials, information of surface finishing, exchange rate, CIF (cost insurance and freight) index, sales administrative expense, and the like.

When the above advance preparation has been completed, the design supporter has a design meeting with a customer or a designer of the manufacturer.

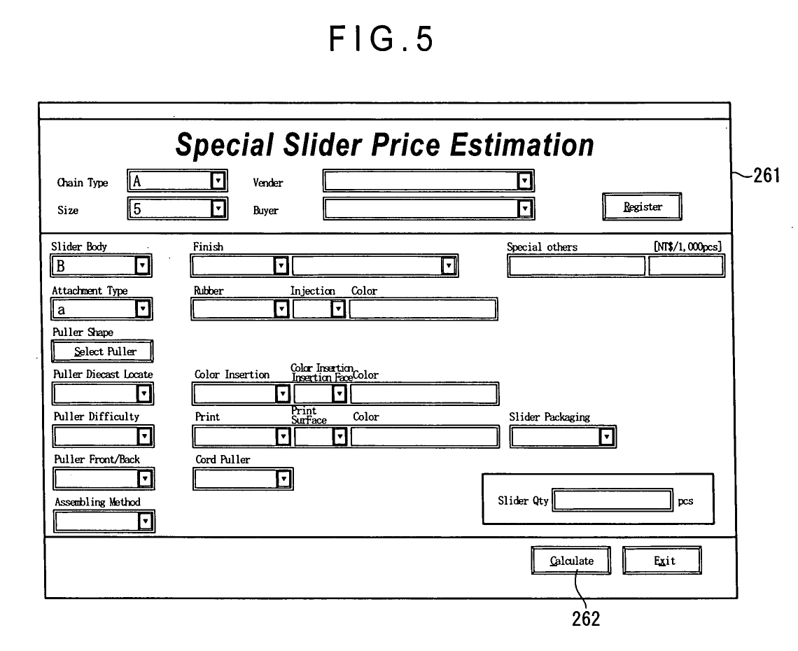

In the meeting, the design supporter performs a manufacturing condition input process by starting the manufacturing condition input section 26A of the design-puller designing apparatus 2 to display a condition input window 261 as shown in FIG. 5 where predetermined information is input (S2).

The condition input window 261 includes entry fields of the manufacturing conditions such as chain type (Chain Type), size, slider body type (Slider Body), vender name (Vender), buyer name (Buyer), attachment type (Attachment Type), material, location of puller diecast (Puller Diecast Locate), difficulty of puller (Puller Difficulty), instruction of front/back (Puller Front/Back), assembling method (Assembling method), surface finish method (Finish), rubber puller (Rubber), location of rubber injection (Injection), coloring condition (Color Insertion), print (Print), cord puller (Cord puller), packaging condition (Slider Packaging), and quantity of slider (Slider Qty).

The design supporter inputs basic information that can be determined before the design of the puller such as vender name, buyer name, chain type, size, and slider body type (Slider Body) into the corresponding entry fields during the meeting with a customer. The above information may also be input after completion of the design of the puller.

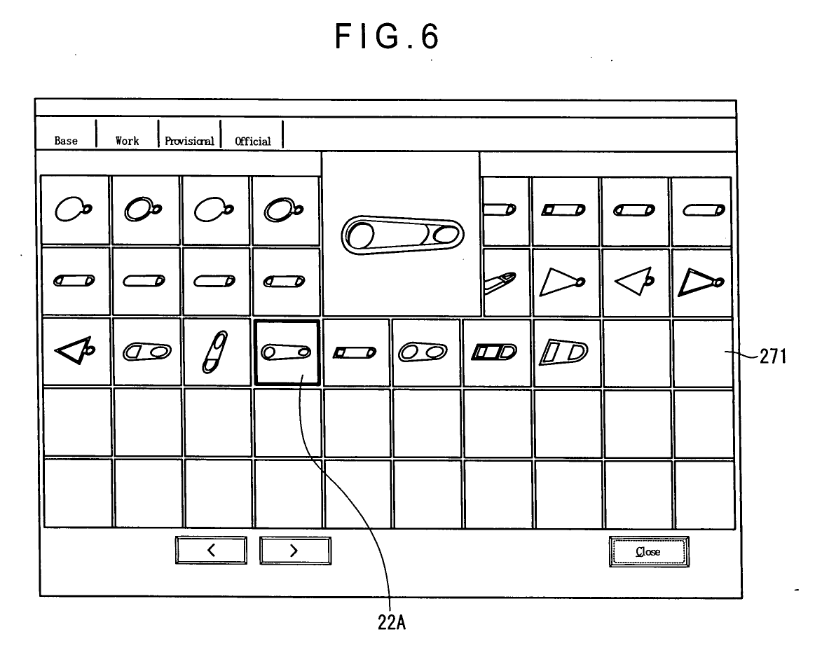

When the design supporter presses a selection button 262 for a puller shape on the condition input window 261, the list display section 27 is activated. The list display section 27 performs a list display process to display a list display window 271 of the data registered in the basic design parts projection data 22 on the screen of the design-puller designing apparatus 2, as shown in FIG. 6 (S3).

The design-puller designing apparatus 2 determines whether a model close to the customer's desired image has been selected from the displayed model list (basic design parts projection data 22) (S4). The list display window continues to be displayed until a model has been selected unless a close button of the list display window 271 is pressed.

When the basic design parts projection data 22 has been selected, the design-puller designing apparatus 2 starts the 3D modeling program 25 to perform a detailed design process (S5).

For example, the basic design parts projection data 22A displayed on the third line from the top and fourth line from the left has been selected in FIG. 6. In this state, when a return key is pressed or a mouse is double-clicked while the projection data 22A is being selected, the 3D modeling program 25 is activated.

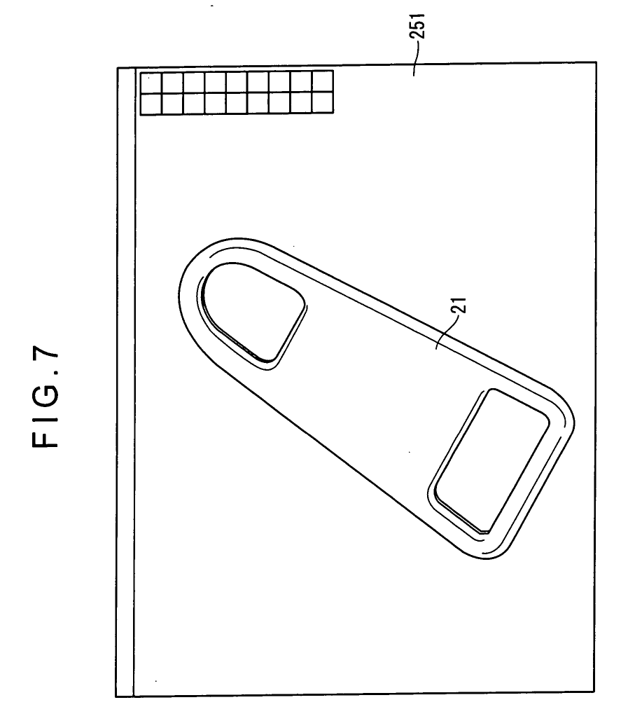

In the detailed design process, the 3D modeling program 25 reads out the basic design parts data 21 which is 3D CAD-based model data corresponding to the selected model to displays the read out data on a design editing window 251, as shown in FIG. 7. It is thus only necessary for the design supporter to appropriately modify the shape of the displayed basic design parts data 21 into the customer's desired design. At this time, the design supporter can create customer's company logo to be printed on the puller if needed.

A concrete method for the shape modification has been set by the 3D modeling program 25. For example, in the case where the 3D modeling program 25 is a 3D CAD system having a parametric function, the shape can be modified simply by changing numerical values of parameterized dimensions or the like. In addition, known design methods of the 3D CAD system can be appropriately used.

The design supporter then presents the modified puller model to the customer for customer approval. When gaining approval of the customer (S6), the design supporter assigns an adequate name to the modified model and stores it in the storage 20 as design data 24 (S7). At the same time, the design supporter uses the 3D modeling program 25 to create image data based on the design data 24. The image data, which is of the same type as the basic design parts projection data 22, can be used when the shape-modified data is checked or printed out. Therefore, the image data should be stored as, for example, JPEG image data.

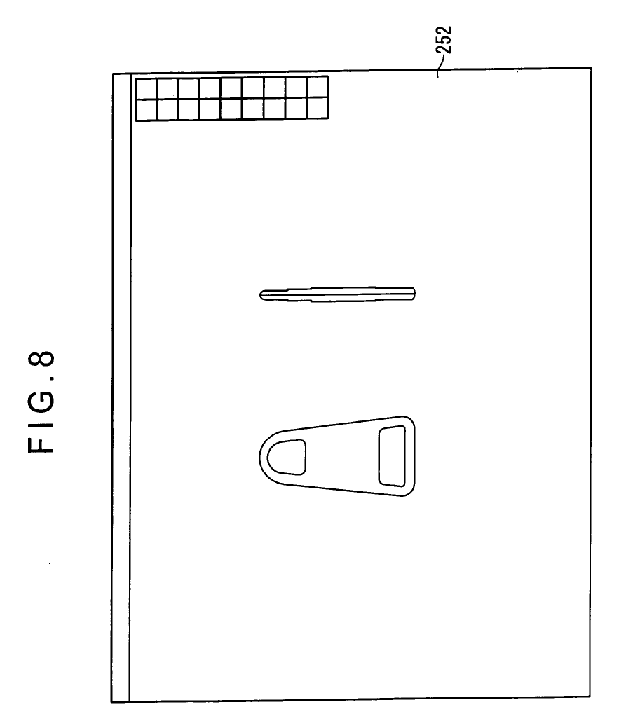

The design supporter then starts the 2D design drawing creation section 25A of the 3D modeling program 25 and performs a 2D design drawing creation process to create a 2D design drawing 252 as shown in FIG. 8 based on the design data 24 and store the created design data by a generalized format such as a CGM (Computer Graphics Metafile) (S8). Since the data is stored by the generalized format, the process data creation/transfer server 5 and the like can handle the data.

The process performed by the 3D modeling program 25 has been completed.

When the process performed by the 3D modeling program 25 has been completed, the design-puller designing apparatus 2 allows the manufacturing condition input window 261 shown in FIG. 5 to be displayed again, where the design supporter again performs the manufacturing condition input process to input various information in accordance with the designed data (S9). For instance, information such as Puller Diecast Locate, Puller Difficulty, Puller Front/Back, Assembling method, Finish, Rubber, Injection, Color Insertion, Print, Cord puller, Slider Packaging, and Slider Qty in the manufacturing condition input window 264 is input in the process.

When the design supporter presses an estimation button (Calculate) 262 on the input window 261 after the input of the required information, the design-puller designing apparatus 2 performs an estimation creation process using the price calculation program 26 (S10).

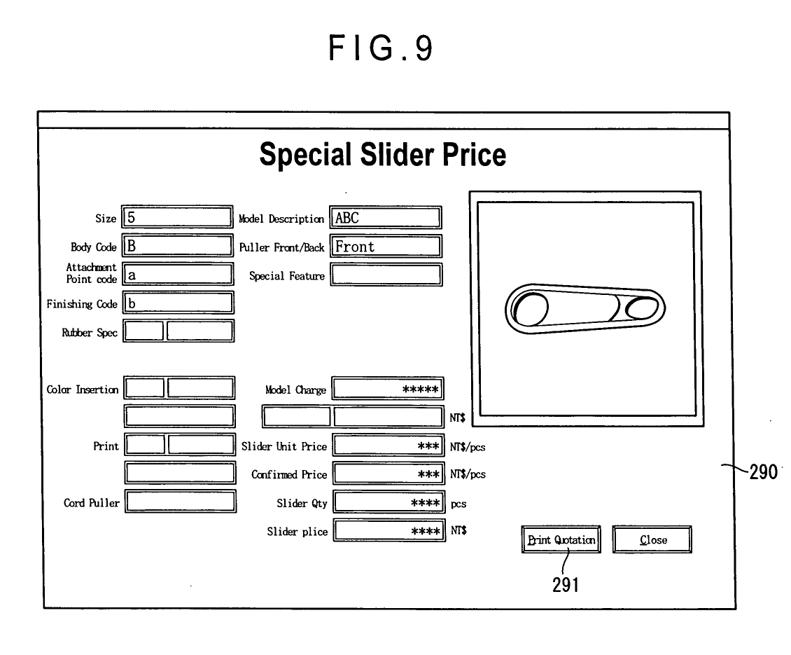

The price calculation program 26 displays a check window 290 to present the input information and estimated cost information calculated from the input information and the design data, as shown in FIG. 9. The design supporter then has a final price negotiation or the like with the customer while viewing the check window 290, inputs the information (discount price and the like), and presses an estimation sheet creation button (Print Quotation) 291. Then, an estimation sheet including a 2D data drawing, image drawing, price, and the like is printed out. The design supporter presents the estimation sheet to the customer and gains the final approval to thereby complete the meeting related to the puller design.

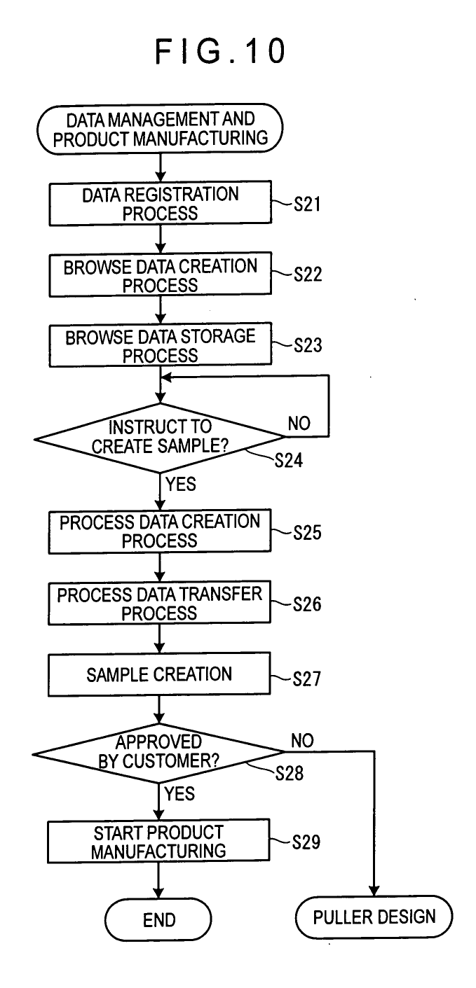

Next, a procedure from the management of the design data that has been determined by the meeting with the customer through the manufacturing of a product or sample will be described with reference to the flowchart of FIG. 10.

After the meeting with the customer, the design supporter or database manager performs a data registration process to register the approved design data 24 and corresponding projection data in the database server 3 (S21).

The above data registration process enables the design data 24 which has been newly designed to be referred to in other countries. Thus, when the customer places an order for a sales representative (design supporter) of another country with the puller corresponding to the design data, the design supporter can easily obtain the shape, price, process data, and the like of the ordered puller without newly creating the design data simply by reading out the design data accumulated in the database server 3, enabling a prompt response to the order.

The browse data server 4 periodically accesses the database server 3. When the newly registered design data 34 exists in the database server 3, the browse data server 4 performs a browse data creation process to read out the design data 34 and create the browse data 41 (S22) and performs a browse data storage process to store the browse data 41 in the storage 40 (S23).

With the above processes, it becomes possible to visually confirm the 3D shape of the newly designed puller on the data browsing apparatus 7 installed in respective business sites or manufacturing plants.

When new design data has been approved, usually, a first product sample is presented to the customer for final approval.

Therefore, when receiving an instruction to create the product sample (S24), a manufacturing plant uses the process data creation/transfer server 5 to perform a process data creation process (S25) and a process data transfer process (S26) to thereby create the first product sample (S27).

More specifically, an operator of the manufacturing plant accesses the browse data server 4 to check the shape of the design data and copies the required design data 34 from the database server 3 to the process data creation/transfer server 5. Then, the operator creates process data in the process data creation/transfer server 5 and transfers the created process data to machines in the plant so as to manufacture the first product sample.

The design supporter presents the first product sample to the customer for final approval. When the final approval of the customer has been gained (S28), the design supporter starts the actual product manufacturing process (S29). On the other hand, the shape modification of the product sample is requested, the design supporter uses the design-puller designing apparatus 2 to carry out the puller design process (S1 to S10) again and creates product sample again for customer's approval.

According to the present invention described above, the following advantages can be obtained.

(1) Since the design-puller designing apparatus 2 includes the 3D modeling program 25 and thereby the design supporter can modify the shape of the design data during the meeting with the customer, the customer's desire can be reflected on the puller shape (design data) in real time, so that the puller according with the customer's desired can be designed quickly.

Further, since the 3D modeling program 25 is used, the customer can check the shape of the designed puller by a 3D image. Thus, the customer can grasp the actual shape of the puller more accurately than in the case where the shape is checked by the 2D design drawing, making it easy to design the puller close to the customer's desired image.

As a result, approval of the customer for the design data can be gained during the meeting with the customer, which significantly shortens the required time to gain the approval for the product design as compared to the conventional communication using FAX or E-mail.

(2) When the design data is created using the 3D modeling program 25, the data is not created from scratch, but is created based on the data close to the shape and the like of the puller that the customer imagines, which has been selected from the prepared basic design parts data 21. Therefore, it is possible to quickly and easily design the puller that the customer desires.

(3) Further, the design-puller designing apparatus 2 uses the 3D modeling program 25 to create the 3D CAD-based model data and thereby can also create the process data from the design data 24 easily in the process data creation/transfer server 5. Therefore, the manufacturing process data can be quickly input to the machines in the plant, reducing the required time to create a first product sample.

As a result, the time required to create the design data and to gain the approval of the customer can be shortened and, at the same time, the time required to present the first sample can be shortened, thereby enhancing customer service. Further, it is possible for the puller manufacturer to make a contract earlier than competitors.

(4) The design-puller designing apparatus 2 includes the price calculation information 23 and price calculation program 26, so that the design supporter can also present the estimated price at the meeting time with the customer and thereby can make price negotiation at the meeting. Also, in this regard, the time required to gain the approval of the customer can be shortened.

Further, the price calculation can be made based on the information of the design data by operating the 3D modeling program 25 and price calculation program 26 simultaneously, so that the price calculation process can also be performed very easily in a short period of time.

(5) The 3D modeling program 25 employs the 3D model with the design data modifiable in a parametric manner, making it possible to very smoothly compare the customer's design image with the created design data, edit the design data, and obtain the approval of the customer at the meeting time. Further, with a certain level of training, even the sales representative or the like can perform the shape modification, so that many sales representatives can utilize the system easily.

(6) The database server 3 is provided to register/manage the master data of the basic design parts data 21, basic design parts projection data 22, and price calculation information 23 which are used in the design-puller designing apparatus 2, so that the new data created in the database management apparatus 6 can be quickly reflected on the respective design-puller designing apparatuses 2.

(7) The browse data server 4 is installed and browse data 41 being a 3D view data is registered in the browse data server 4. Therefore, the sales representatives and plant operators can browse the design data in a 3D manner and easily check the shape and the like on the data browsing apparatuses 7 which are installed in the business sites and plants or carried by the sales representatives.

(8) Since the process data creation/transfer server 5 is installed, the process data can be created based on the design data and transferred to the machines in the plant, so that a product sample or a product can be manufacturer easily.

In addition, when the process data transfer section 56 is arranged to search a plant that is suitable for processing the designed product based on information based on information such as the operating state of the plants or production lines, the type of the product machines and the like, the product management can be performed more effectively, thereby shortening the time period for sample presentation date and product delivery date.

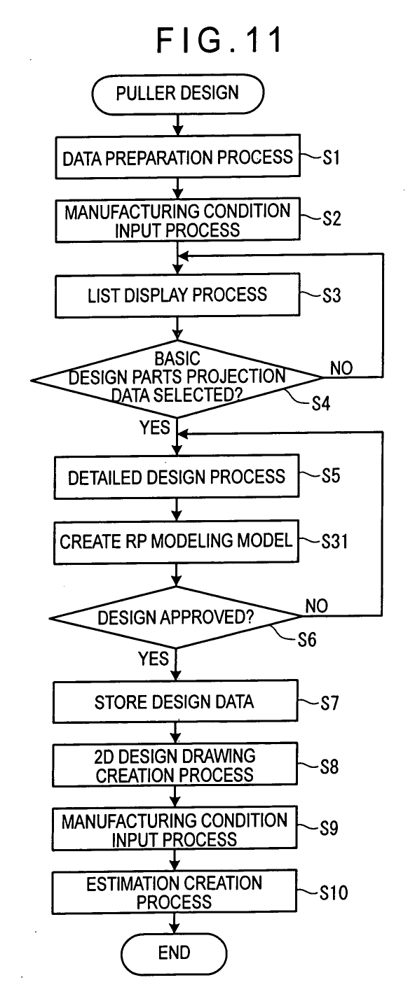

Next, a second embodiment of the present invention will be described with reference to FIG. 11.

The second embodiment differs from the first embodiment only in that a 3D modeling device (3D printer) utilizing a rapid prototyping technology is added to the system, and that an RP modeling model creation process S31 is added after the detailed design process S5.

In the RP modeling model creation process S31, the 3D printer utilizing the rapid prototyping technology is used to create a product sample (trial product) based on the 3D CAD-based model data designed in the detailed design process S5. Thus, a product sample creation process is constituted by the RP modeling model creation process S31.

Examples of the rapid prototyping technology (RP) used in the RP modeling model creation process S31 include known rapid prototyping technologies such as optical modeling method, powder sintering method, ink-jet method, sheet laminating method, extrusion method and other modeling methods. In particular, the rapid prototyping technology utilizing the ink-jet method, which is called 3D printer, can output 3D CAD data in a printer-like manner to model a 3D trial product, which can be handled easily and a product sample can be created in a short period of time.

With the above RP modeling model creation process S31, the product sample can be created by using the rapid prototyping technology, so that the 3D model of the designed product can be prepared in a very short time. Thus, the customer can confirm the design by visually checking the product sample. Therefore, the actual product image can be grasped more easily than in the case of the first embodiment, where the design is checked based on only the 3D data displayed on the screen, which shortens the required time to gain approval for the design.

Further, when the product sample is created by using the rapid prototyping technology, it is possible to create the product sample at lower cost and in a shorter time than in the case of the sample creation process S27 of the first embodiment, where the product sample is created using the actual product line. Therefore, the customer's desired design can easily be designed by repeating the detail design process S5, RP modeling model creation process S31, and design approval process S6. As a result, it is possible to reduce the possibility that the design modification occurs in the customer approval process S28 after the sample creation process S27 in which the actual product line has been used, thereby minimizing the loss due to redesign.

The product sample creation process may be performed in the plant that actually manufactures the product, the business site, or at the meeting site with the customer. In particular, when the 3D printer utilizing the ink-jet method is used, it is possible to carry the 3D printer to the customer's company to create the product sample as well as to install the 3D printer at the business site, since the size reduction of the 3D printer has been achieved comparatively.

When the product sample is created at the site near the customer's location, such as business site or customer's company, it is possible to shorten the time for presenting the product sample to the customer and thereby to further shorten the time for the customer's design approval. When, in particular, the product sample is created in the customer's company, the design can be easily modified while checking the product sample, so that the product design according to the customer's desire can be realized in a short time.

In the product sample creation process using the rapid prototyping technology, the product sample having the same shape as the designed product is created usually by using a different material (photopolymerizable resin, etc.) from that of the actual product. On the other hand, in the case of the powder sintering method, ceramics or metallic powder can be used, a sample made of the same material as the actual product can be created. When the sample made of the same material as the actual product can be obtained as described above, the customer can grasp the texture of the actual product, which can further shorten the time for the customer's design approval.

The present invention is not limited to the above embodiments. For example, in the above embodiments, since the design-puller designing apparatus 2 includes the basic design parts data 21, basic design parts projection data 22, price calculation information 23, 3D modeling program 25, and price calculation program 26, the apparatus 2 can be operated as a stand-alone apparatus. Alternatively, however, when the design-puller designing apparatus 2 is installed at the meeting room of the manufacturer and connected to the database server 3 and the like through a high-speed network, the design-puller designing apparatus 2 need not store the above data and the design modification can be performed by directly referring to the master data.

Although the design-puller designing apparatus 2 is used in the puller design production management system 1 in the above embodiment, it may also be used independently. In other words, the design data that has been designed on the design-puller designing apparatus 2 may directly be transmitted to the process data creation/transfer server 5. In this case, the database server 3 or browse data server 4 does not have to be installed. However, with an arrangement having the puller design production management system 1 as in the case of the above embodiment, usability can be further enhanced as the master data can be shared and that the 3D view data can be browed.

Although the 3D modeling program 25 of the design-puller designing apparatus 2 includes the 2D design drawing creation section 25A in the above embodiment, the 2D design drawing creation section 25A may not be provided. Further, the design-puller designing apparatus 2 includes the price calculation program 26 and thereby can create the estimation sheet in the above embodiment. However, when only the shape modification of the data is performed on the design-puller designing apparatus 2 and the estimation is performed separately, the price calculation program 26 may not be provided.

The 3D modeling program 25 may utilize a non-parametric type CAD system in addition to the parametric CAD system.

In the RP modeling model creation process S31 of the second embodiment, the rapid prototyping technology is used to directly create the trial product. Alternatively, however, a metal mold creation process in which the rapid prototyping technology is used to create the metal mold of the product based on the designed 3D CAD-based model data and a trial product manufacturing process in which the metal mold that has been created in the metal mold creation process is used to manufacture the product sample may be provided in place of the RP modeling model creation process S31.

The rapid prototyping technology mentioned here may be the one where the metal mold can be created by using a metallic material like the abovementioned powder sintering method. By creating the metal mold and using the created metal mold to manufacture the product sample as described above, a 3D modeling product corresponding to the designed product can be created in a very short time. Therefore, the customer can approve the design by visually checking the product sample, so that the customer can easily grasp the actual product image, thereby significantly shortening the time until the design approval is obtained.

In the case where the sample is directly created using the rapid prototyping technology, a product sample that cannot actually be manufactured by the metal mold may be created in some cases due to difference in the modeling method between the rapid prototyping technology and actual manufacturing process using the metal mold. When, on the other hand, the metal mold is created and the created metal mold is used to create the product sample, there is an advantage where the possible problem in the actual manufacturing process can be verified.

Although the metal mold creation process and trial product manufacturing process are usually performed in the plant that actually manufactures the product, the above processes may be performed in the business site near the customer's company or at the meeting site with the customer. In particular, in the case of the manufacturing of the slide fastener or button the size of which is very small, a small-sized injection molding machine can be used. Thus, when a machine for creating the metal mold using the powder sintering method and another machine for manufacturing the product using the metal mold such as the injection molding machine are installed on the truck or trailer and conveyed to the business site or customer's company, the metal mold and product sample can be created at the location near the customer, such as the business site or customer's company. As a result, it is possible to shorten the time for presenting the product sample to the customer and thereby to further shorten the time for the customer's design approval.

The metal mold may be created using the rapid prototyping technology and the sample may be created using the metal mold at the time point when the design is fixed after the RP modeling model creation process S31 of the second embodiment. In such arrangement, the sample can be created at low cost and in a short time by the 3D printer using photopolymerizable resin or the like during the trial and error stage of designing. Further, by performing the metal mold creation process and trial product manufacturing process at the time point when the design is fixed, the trial product made of the same material as the actual product can be created, so that the texture and the like can also be checked.

The product designing apparatus 2 of the present invention can be used not only for the design of the puller of the slider, but for the design of the slider body and the like. In addition, the product designing apparatus 2 can be used for the design of various products such as buckle, karabiner, cord stopper, and button as well as for the design of various products including: various building materials such as sash window and door; and various material parts such as operation handle, a lever, and a lock. In particular, the product designing apparatus 2 of the present invention is suitable for the design of the product used for garments, bags, or shoes having a plurality of types of basic shapes which are used as master data and having various types mainly in terms of design.

The priority application Number JP 2004-257493 upon which this patent application is based is hereby incorporated by reference.

What is claimed is:

1. A product design method for designing a product using a computer, comprising:
a data preparation process for preparing 3D CAD-based model data serving as basic shapes of a plurality of products different from one another in terms of design and 2D product projection data corresponding to the 3D CAD-based model data;
a list display process for displaying a list of the product projection data on a screen of the computer; and
a detailed design process for displaying the 3D CAD-based model data corresponding to the product projection data selected from the displayed list of the product projection data on the screen and for performing a shape modification of the 3D CAD-based model data through an operator's operation.

2. The product design method according to claim 1, wherein
the 3D CAD-based model data is parametric data having parameters for the shape modification, and the operator changes the parameters to perform the shape modification of the 3D CAD-based model data.

3. The product design method according to claim 1, further comprising an estimation creation process for creating an estimation of a price of a product based on the 3D CAD-based model data whose shape has been modified in the detailed design process.

4. The product design method according to claim 3, further comprising a manufacturing condition input process for inputting manufacturing condition data including at least a product material and a manufacturing method, wherein
in the estimation creation process, the estimation of the price of the product is created based on the 3D CAD-based model data and the manufacturing condition data.

5. The product design method according to claim 1, further comprising a 2D design drawing creation process for creating a 2D design drawing based on the 3D CAD-based model data whose shape has been modified in the detailed design process.

6. The product design method according to claim 1, wherein
the product is a slide fastener, a slide fastener part, a button, a coupling tool, or a locking tool.

7. The product design method according to claim 1, further comprising:
a browse data creation process for creating browse data based on the designed 3D CAD-based model data; and
a browse data display process for displaying the browse data when a display of the created browse data is instructed.

8. The product design method according to claim 1, further comprising:
a process data creation process for creating product process data based on the designed 3D CAD-based model data; and
a process data transfer process for transferring the created product process data to a manufacturing plant.

9. The product design method according to claim 1, further comprising a product sample creation process for creating a product sample based on the designed 3D CAD-based model data by a rapid prototyping technology.

10. The product design method according to claim 1, further comprising:
a metal mold creation process for creating a metal mold of a product based on the designed 3D CAD-based model data by a rapid prototyping technology; and
a trial product manufacturing process for creating a product sample by using the metal mold created in the metal mold creation process.

11. A product design apparatus for designing a product using a computer, comprising:
a basic data storage unit for storing 3D CAD-based model data of a plurality of products different from one another in terms of design and 2D product projection data corresponding to the 3D CAD-based model data;
a list display section for displaying a list of the product projection data on a screen of the computer;
a detailed design unit for displaying the 3D CAD-based model data corresponding to the product projection data selected from the displayed list of the product projection data and for performing a shape modification of the 3D CAD-based model data through an operator's operation; and
a design data storage unit for storing the 3D CAD-based model data that has been designed by the detailed design unit.

12. The product design apparatus according to claim 11, wherein
the 3D CAD-based model data is parametric data having parameters for the shape modification, and the detailed design unit changes the parameters to perform the shape modification of the 3D CAD-based model data.

13. The product design apparatus according to claim 11, further comprising an estimation creation unit for creating an estimation of a price of a product based on the 3D CAD-based model data whose shape has been modified by the detailed design unit.

14. The product design apparatus according to claim 13, wherein
the estimation creation unit includes a manufacturing condition input section through which manufacturing condition data including at least a product material and a manufacturing method is input, the estimation creation unit creating the estimation of the price of the product based on the 3D CAD-based model data and the manufacturing condition data.

15. The product design apparatus according to claim 11, wherein
the detailed design unit includes a 2D design drawing creation section for creating a 2D design drawing based on the 3D CAD-based model data.

16. The product design apparatus according to claim 11, wherein
the product is a slide fastener, a slide fastener part, a button, a coupling tool, or a locking tool.

17. A product design system comprising:
a product design apparatus for designing a product using a computer;
a database server connected to the product design apparatus through an electrical communication line and accumulating 3D CAD-based model data designed by the product design apparatus;
a browse data server connected to the database server through an electrical communication line and including a browse data creation unit for creating browse data based on the 3D CAD-based model data accumulated in the database server and a data storage unit for accumulating the browse data; and
a data browsing apparatus connected to the browse data server through an electrical communication line and including a browse data display unit for displaying the browse data accumulated in the browse data server, wherein
the product design apparatus comprises:
a basic data storage unit for storing 3D CAD-based model data of a plurality of products different from one another in terms of design and 2D product projection data corresponding to the 3D CAD-based model data;
a list display section for displaying a list of the product projection data on a screen of the computer;
a detailed design unit for displaying the 3D CAD-based model data corresponding to the product projection data selected from the displayed list of the product projection data and for performing a shape modification of the 3D CAD-based model data through an operator's operation; and
a design data storage unit for storing the 3D CAD-based model data that has been designed by the detailed design unit.

18. The product design system according to claim 17, further comprising a process data creation/transfer server connected to the database server through an electrical communication line and including a process data creation unit for creating product process data based on the 3D CAD-based model data recorded in the database server and a process data transfer unit for transferring the product process data to a manufacturing plant.

19. The product design system according to claim 17, further comprising a 3D modeling apparatus for creating a product sample based on the designed 3D CAD-based model data designed by the product design apparatus by a rapid prototyping technology.

20. The product design system according to claim 17, further comprising:
a metal mold creation apparatus for creating a metal mold of a product based on the designed 3D CAD-based model data designed by the product design apparatus by a rapid prototyping technology; and
a trial product manufacturing apparatus for manufacturing a trial product using the metal mold created by the metal mold creation apparatus.

21. A product design program which allows a computer to execute a product design method for designing a product using a computer, wherein
the product design method comprises:
a data preparation process for preparing 3D CAD-based model data serving as basic shapes of a plurality of products different from one another in terms of design and 2D product projection data corresponding to the 3D CAD-based model data;
a list display process for displaying a list of the product projection data on a screen of the computer; and
a detailed design process for displaying the 3D CAD-based model data corresponding to the product projection data selected from the displayed list of the product projection data on the screen and for performing a shape modification of the 3D CAD-based model data through an operator's operation.
